(19) United States
(12) Patent Application Publication
(10) Pub. No.: US 2024/0283312 A1
(43) Pub. Date: Aug. 22, 2024

(54) MOTOR ASSEMBLY AND CLOTHING PROCESSING DEVICE COMPRISING SAME

(71) Applicant: SAMSUNG ELECTRONICS CO., LTD., Suwon-si Gyeonggi-do (KR)

(72) Inventors: Yongwoo NAM, Suwon-si (KR); Deokjin KIM, Suwon-si (KR); Jinwoo CHO, Suwon-si (KR); Ukho SEO, Suwon-si (KR); Jaewoong JUNG, Suwon-si (KR)

(73) Assignee: SAMSUNG ELECTRONICS CO., LTD., Suwon-si Gyeonggi-do (KR)

(21) Appl. No.: 18/653,208

(22) Filed: May 2, 2024

Related U.S. Application Data
(63) Continuation of application No. PCT/KR2022/016981, filed on Nov. 2, 2022.

(30) Foreign Application Priority Data
Jan. 10, 2022 (KR) 10-2022-0003349

(51) Int. Cl. H02K 1/28; B29C 45/14; B29K 105/20; B29L 31/00; D06F 23/06; D06F 37/30; H02K 1/2791; H02K 15/12; H02K 21/22

(52) U.S. Cl. CPC H02K 1/28; B29C 45/14467; D06F 23/06; D06F 37/304; H02K 1/2791; H02K 15/12; H02K 21/22; B29C 2045/1454; B29K 2105/20; B29K 2105/203; B29L 2031/7498

(57) ABSTRACT

An embodiment of the present invention relates to a motor assembly in which a rotor comprises: a rotor frame including a bottom surface having a rotating shaft at the center thereof and a side wall extending from the circumference of the bottom surface to surround the rotor in a circumferential direction; a plurality of cores disposed at the side wall along the circumferential direction; a plurality of permanent magnets disposed at the side wall along the circumferential direction and disposed between the plurality of cores, respectively; and an outer ring disposed at an outer surface, which is the opposite to the center of the rotor frame, along the circumferential direction, of the side wall, wherein the outer ring may be disposed apart from the plurality of cores and have the side wall therebetween. Various other embodiments may also be possible.

### CROSS-REFERENCE TO RELATED APPLICATIONS

This application is a continuation of International Application PCT/KR2022/016981, filed Nov. 2, 2022, and claims foreign priority to Korean Application 10-2022-0003349, filed Jan. 10, 2022, which are incorporated herein by reference in their entireties.

### TECHNICAL FIELD

Various embodiments described herein relate to a motor assembly and a clothing processing device including the motor assembly.

### BACKGROUND ART

A clothing processing device refers to a device that performs various clothing management tasks such as washing, drying, deodorization, or wrinkle removal and may include, for example, a washing machine and a drying machine.

A washing machine, as one of various clothing processing devices, refers to a machine that automatically washes laundry including clothing using electricity and may be configured to perform washing, rinsing, draining, and dewatering cycles according to a motion input from a user. The washing machine, which generally includes a tub receiving therein a certain amount of water and a drum rotatably installed inside the tub, may perform each laundering cycle as the drum containing laundry inside the tub is rotated by a motor assembly being driven.

### DISCLOSURE OF INVENTION

### Technical Goals

A motor assembly may rotate a drum as a rotor connected to the drum through a shaft is rotated by an electromagnetic interaction between the rotor and a stator. To rotate the drum at high speed and improve the power efficiency, the motor assembly of a clothing processing device may have a stacked structure or an increased outer diameter, but there may still be a limitation in securing an internal space of the clothing processing device. To overcome this, there is a technical need to improve the driving efficiency of the motor assembly and implement the motor assembly to be thinner and more compact.

According to various embodiments described herein, a motor assembly and an electronic device including the motor assembly may include an outer ring coupled to an outer surface of a rotor frame, thereby improving the power efficiency of the motor assembly and downsizing the motor assembly.

The technical goals to be achieved through the various embodiments disclosed herein are not limited to the technical goals described above, and other technical goals not described above may also be clearly understood by a person having ordinary skill in the art to which the present disclosure pertains from the following description.

### Technical Solutions

According to an embodiment of the present disclosure, there is provided a motor assembly including a stator and a rotor configured to electromagnetically interact with the stator to rotate about a rotation axis, in which the rotor includes: a rotor frame including a bottom surface centered on the rotation axis and a side wall extending from a circumference of the bottom surface to surround the rotor in a circumferential direction of the rotor; a plurality of cores on the side wall along the circumferential direction; a plurality of permanent magnets on the side wall along the circumferential direction and between the plurality of cores, respectively; and an outer ring on an outer surface of the side wall, extending along the circumferential direction, and spaced apart from the plurality of cores with the side wall therebetween.

According to an embodiment of the present disclosure, the rotor frame includes a locking member protruding from the outer surface of the side wall and supporting the outer ring, and the outer ring includes a locking groove having a shape corresponding to the locking member such that the locking member is inserted therein.

According to an embodiment of the present disclosure, the rotor frame includes a plurality of locking members as the locking member such that the plurality of locking members are spaced apart in the circumferential direction, and the outer ring includes a plurality of locking grooves as the locking groove such that the plurality of locking grooves respectively correspond to positions of the plurality of locking members.

According to an embodiment of the present disclosure, the locking groove is a hole that penetrates the outer ring from a first side of the outer ring facing the rotor frame to a second side of the outer ring opposite to the first side.

According to an embodiment of the present disclosure, the rotor frame includes a seating groove that is bent from the outer surface of the side wall toward a center of the rotor frame and in which the outer ring is seated.

According to an embodiment of the present disclosure, the outer ring includes a first surface facing the rotor frame, a second surface opposite the first surface, and a third surface extending from the first surface to the second surface, and the seating groove includes a first bent area bent from the outer surface of the side wall and facing the third surface of the outer ring, and a second bent area bent from the first bent area and facing the first surface of the outer ring.

According to an embodiment of the present disclosure, the rotation shaft is connected to the rotor frame, and the rotor frame has a serration on the bottom surface of the rotor frame coupling the rotor to the rotation shaft.

According to an embodiment of the present disclosure, the plurality of cores is disposed such that a centroid of the plurality of cores is spaced apart from a centroid of the serration in a direction along an axial direction of the rotation shaft, and the outer ring is disposed such that a centroid of the outer ring is spaced apart from the centroid of the plurality of cores in the direction along the axial direction of the rotation shaft.

According to an embodiment of the present disclosure, the outer ring has a height in the direction along the axial direction of the rotation shaft that is smaller than a height of the plurality of cores in the direction along the axial direction of the rotation shaft.

According to an embodiment of the present disclosure, the motor assembly further includes a bonding member between the outer ring and the rotor frame to support the outer ring.

According to an embodiment of the present disclosure, the outer ring is spaced apart from the plurality of cores and the plurality of permanent magnets with the side wall therebetween.

According to an embodiment of the present disclosure, the outer ring is spaced apart at a distance that is substantially between 1 millimeter (mm) and 2 mm from at least a portion of the plurality of cores.

According to an embodiment of the present disclosure, the side wall includes a plurality of first insertion grooves formed therein and a plurality of second insertion grooves respectively between the plurality of first insertion grooves, the plurality of cores is formed in the plurality of first insertion grooves, and the plurality of permanent magnets is formed in the plurality of second insertion grooves.

According to an embodiment of the present disclosure, the rotor frame is an injection molded single body. According to another embodiment of the present disclosure, there is provided a clothing processing device including: a main body in which a tub is provided; a drum rotatably disposed inside the tub; and a motor assembly including a stator, a rotor configured to electromagnetically interact with the stator to rotate about a rotation axis, and a shaft connected to the drum to rotate the drum about the rotation axis. The rotor may include: a rotor frame including a bottom surface centered on the rotation axis and a side wall extending from a circumference of the bottom surface to circumferentially surround the rotor in a first direction; a serration formed on the bottom surface of the rotor frame and provided for coupling the shaft; a plurality of cores disposed on the side wall along the circumferential direction; a plurality of permanent magnets disposed on the side wall along the circumferential direction and disposed between the plurality of cores, respectively; and an outer ring disposed on an outer surface of the side wall that is opposite to a center of the rotor frame, along the circumferential direction. The outer ring may be disposed such that a centroid of the outer ring is spaced apart from a centroid of the plurality of cores in the first direction.

According to still another embodiment of the present disclosure, there is provided a method including: forming an injection molded outer ring having a locking groove; arranging a plurality of permanent magnets and a plurality of cores inside a cavity of a mold; arranging the outer ring having the locking groove inside the cavity and spaced apart from the plurality of cores; and injecting a material into the cavity to form a rotor frame having a side wall between the plurality of cores and the outer ring and a locking member on the side wall and configured to be inserted into the locking groove, wherein the rotor frame is a rotor frame of a rotor that is electromagnetically interactable with a stator to rotate about a rotation axis.

According to an embodiment, a motor assembly and a clothing processing device including the motor assembly may have an outer ring coupled to an outer surface of a rotor frame, thereby improving the performance of a driving device using a permanent magnet and preventing shatters that may occur by a high-speed rotation of the motor assembly.

Alternatively, according to an embodiment, a motor assembly and a clothing processing device including the motor assembly may have an outer ring that is disposed on an outermost surface of a rotor frame to secure a distance between the outer ring and a core and reduce an outer diameter of the rotor frame, thereby downsizing the motor assembly.

### BRIEF DESCRIPTION OF DRAWINGS

FIG. 1 is a perspective view of a clothing processing device according to an embodiment of the present disclosure.

FIG. 2 is a cross-sectional view of a clothing processing device according to an embodiment of the present disclosure.

FIG. 3 is a block diagram illustrating a configuration of a clothing processing device according to an embodiment of the present disclosure.

FIG. 4 is an exploded perspective view of a motor assembly according to an embodiment of the present disclosure.

FIG. 5A is a perspective view of a rotor according to an embodiment of the present disclosure.

FIG. 5B is a cross-sectional view of a rotor according to an embodiment of the present disclosure.

FIG. 5C is a cross-sectional perspective view of a rotor according to an embodiment of the present disclosure.

FIG. 6 is a cross-sectional view of a partial area of a rotor according to an embodiment of the present disclosure.

FIG. 7 is an exploded perspective view of a rotor according to an embodiment of the present disclosure.

FIG. 8 is a cross-sectional perspective view of a partial area of a rotor according to an embodiment of the present disclosure.

FIG. 9 is a cross-sectional perspective view of a partial area of a rotor according to an embodiment of the present disclosure.

FIG. 10 is a flowchart illustrating a method of manufacturing a motor assembly according to an embodiment of the present disclosure.

### BEST MODE FOR CARRYING OUT INVENTION

Hereinafter, embodiments will be described in detail with reference to the accompanying drawings. When describing the embodiments with reference to the accompanying drawings, like reference numerals refer to like components and a repeated description related thereto will be omitted.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B,” “at least one of A and B,” “at least one of A or B,” “A, B or C,” “at least one of A, B and C,” and “A, B, or C,” each of which may include any one of the items listed together in the corresponding one of the phrases, or all possible combinations thereof. Terms such as “first” or “second,” or “1st” or “2nd” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in the form of an application-specific integrated circuit (ASIC).

Various embodiments set forth herein may be implemented as software (e.g., a program) including one or more instructions that are stored in a storage medium (e.g., an internal memory or an external memory) that is readable by a machine (e.g., an electronic device). For example, a processor of the machine (e.g., the electronic device) may invoke at least one of the one or more instructions stored in the storage medium and execute it. This allows the machine to be operated to perform at least one function according to the at least one instruction invoked. The one or more instructions may include code generated by a complier or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to various embodiments, a method according to an embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™) or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

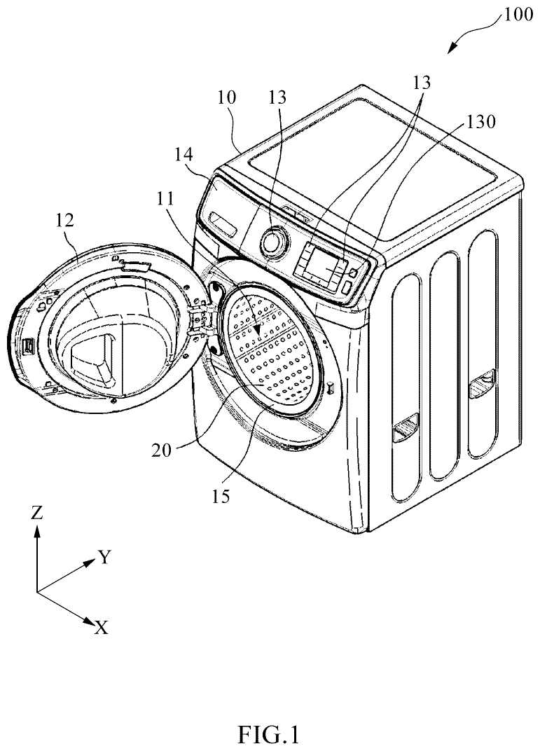

Hereinafter, according to various embodiments of the present disclosure, a motor assembly and a clothing processing device including the motor assembly, and a method of manufacturing of the motor assembly will be described in detail with reference to FIGS. 1 to 9.

FIG. 1 is a perspective view of a clothing processing device 100 according to an embodiment of the present disclosure.

Referring to FIG. 1, the clothing processing device 100 of an embodiment may include a main body 10.

In an embodiment, the clothing processing device 100, which is a device configured to manage or clean clothing, may include, for example, a washing machine, a drying machine, or a clothing care device. Hereinafter, a washing machine will be described as an example of the clothing processing device 100, but examples are not limited thereto in actual implementations and various types may be implemented as the clothing processing device 100.

In an embodiment, the clothing processing device 100 may refer to a device that washes laundry using water and detergent and dewaters the wet laundry. In addition, depending on embodiments, the clothing processing device 100 may dry laundry that has already been dewatered.

In an embodiment, the clothing processing device 100 may be classified into one of the following types: a top-loading type in which an inlet 11 is provided at the top of the main body 10 and a rotation shaft of a tub 15 is vertical to the ground; a front-loading type in which the inlet 11 is provided in the front of the main body 10 and the rotation shaft of the tub 15 is horizontal to the ground; and a hybrid type that combines the foregoing types. In this case, a top-loading washing machine may also be referred to as a “general washing machine” or a “top-loader washing machine,” and a front-loading washing machine may also be referred to as a “drum washing machine.” Although the drum washing machine of the front-loading type is shown in FIG. 1 as an example, the clothing processing device 100 of an embodiment is not limited thereto.

In an embodiment, the main body 10 may form the exterior of the clothing processing device 100, and the laundry inlet 11 through which laundry is put into and taken out of the main body 10 may be provided in the front of the main body 10. A door 12 may be installed on the laundry inlet 11 to be opened and closed. The clothing processing device 100 may receive laundry into a drum 20 of the tub 15 disposed inside through the inlet 11.

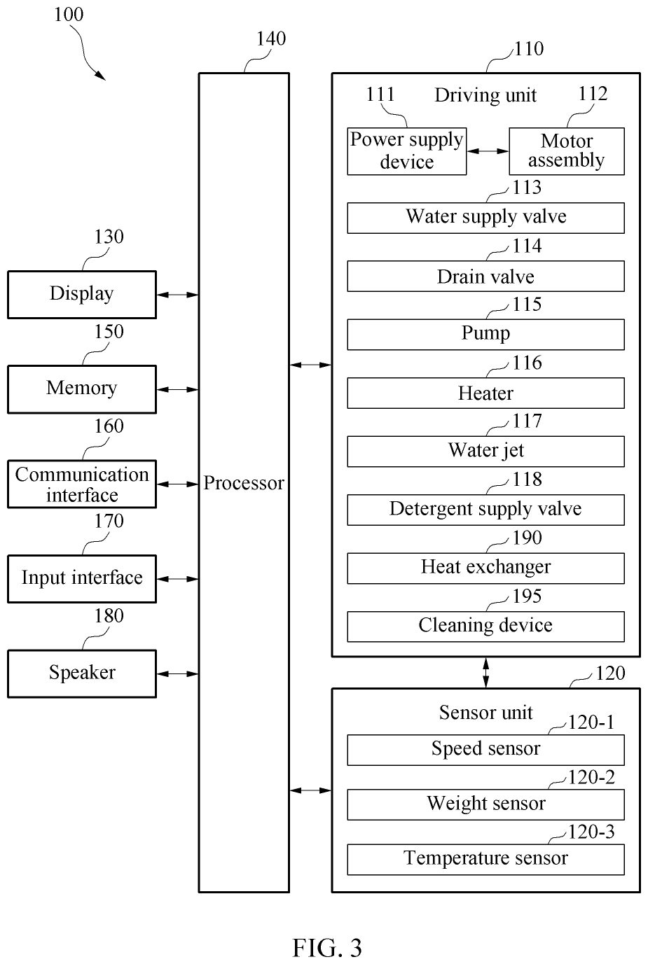

In an embodiment, an input device 13 including a plurality of buttons or a rotary lever that is operable by a user may be provided in the front of the main body 10 to provide an input module (e.g., an input interface 170 in FIG. 3) for receiving a user command from the user of the clothing processing device 100. In addition, a display 130 for displaying information related to the clothing processing device 100 and laundering may be provided in the front of the main body 10.

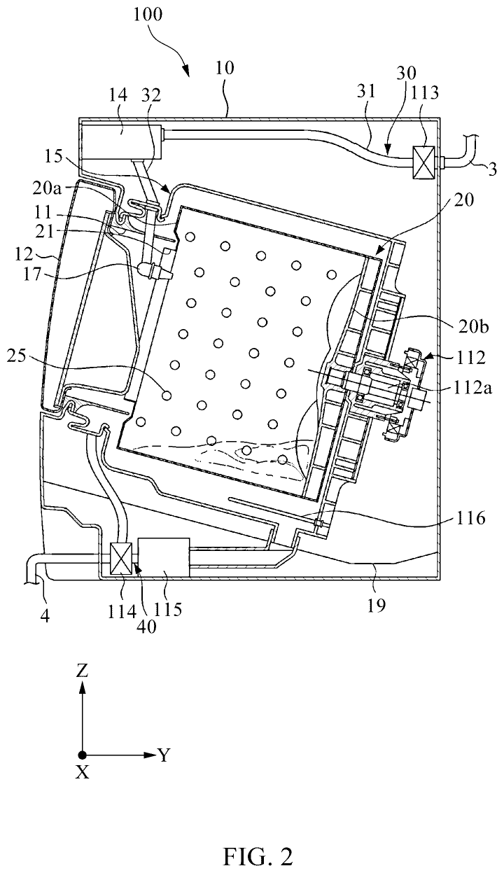

In an embodiment, a detergent receiving portion 14 may supply detergent or fabric softener to the tub 15 of the clothing processing device 100. The detergent receiving portion 14 may transfer detergent to the drum 20 in a washing water supply process. For example, when a water supply valve (e.g., a water supply valve 113 in FIG. 2) is opened and water is supplied to a water supply pipe (e.g., a water supply pipe 30 in FIG. 2), the water may be provided to the detergent receiving portion 14, and the detergent or fabric softener received in the detergent receiving portion 14 may be mixed with the water. Accordingly, the water mixed with the detergent or fabric softener may be supplied to the tub 15.

FIG. 2 is a cross-sectional view of the clothing processing device 100 according to an embodiment of the present disclosure.

Referring to FIG. 2, the clothing processing device 100 may include at least some of a tub 15, a drum 20, a water supply pipe 30, and a drainpipe 40.

In an embodiment, the clothing processing device 100 may be combined with at least one configuration or feature of the previously described embodiments unless clearly technically impossible.

In an embodiment, the tub 15 may be provided inside a main body 10 of the clothing processing device 100 and may be formed in a cylindrical shape with an opening facing a laundry inlet 11. The tub 15 may store therein a predetermined amount of water required for washing. On the bottom of the main body 10, a water storage portion 19 in which washing water leaking from the tub 15 is stored without leaking to the outside may be formed.

In an embodiment, the tub 15 may be installed on an installation surface (e.g., a horizontal surface) of the clothing processing device 100 at a preset angle such that a front portion of the tub 15 is disposed to be higher than a rear portion of the tub 15 inside the main body 10.

For example, it may be installed such that a front portion 20a of the drum 20 is disposed to be higher than a rear portion 20b of the drum 20, that is, may be installed to have a preset angle (e.g., 5 degrees (°), 15°, or 30°) with respect to a horizontal plane. However, examples are not limited thereto, and the front portion 20a and the rear portion 20b of the drum 20 may be installed not to be tilted without an angle (e.g., 0°).

In an embodiment, the drum 20 may be installed inside the tub 15 at the same angle as a water tank. Here, the front portion described herein may refer to a surface on which the opening is formed in the same direction as the inlet 11 of the main body 10 such that laundry is loaded, and the rear portion described herein may refer to a surface opposite to the front portion. Alternatively, the tub 15 may be disposed so as not to be tilted, and thus a rotation shaft of the drum 20 may be provided in a direction parallel to the ground.

In an embodiment, the drum 20 may be installed inside the tub 15 and provided in a substantially cylindrical shape to form a space for receiving therein the loaded laundry and washing the laundry. The opening corresponding to the laundry inlet 11 may be provided in the front of the drum 20, through which laundry may be loaded into the drum 20.

In an embodiment, a plurality of through holes 25 may be formed in the drum 20, and washing water inside the drum 20 may escape through the plurality of through holes 25 to be drained into an external drainpipe 4. For example, during a water supply cycle of the clothing processing device 100, washing water supplied from an external water supply pipe 3 may be supplied to the inside of the tub 15 through a nozzle connected to the water supply pipe 30. In addition, during a dewatering cycle of the clothing processing device 100, the drum 20 may rotate at a high speed by a motor assembly 112, and a centrifugal force generated by the rotation of the drum 20 may allow the washing water inside the drum 20 to escape to the outside of the drum 20 through the plurality of through holes 25 and allow the washing water received in a space between an outer wall of the drum 20 and an inner wall of the tub 15 to be drained along the drainpipe 40 into the drainpipe 4.

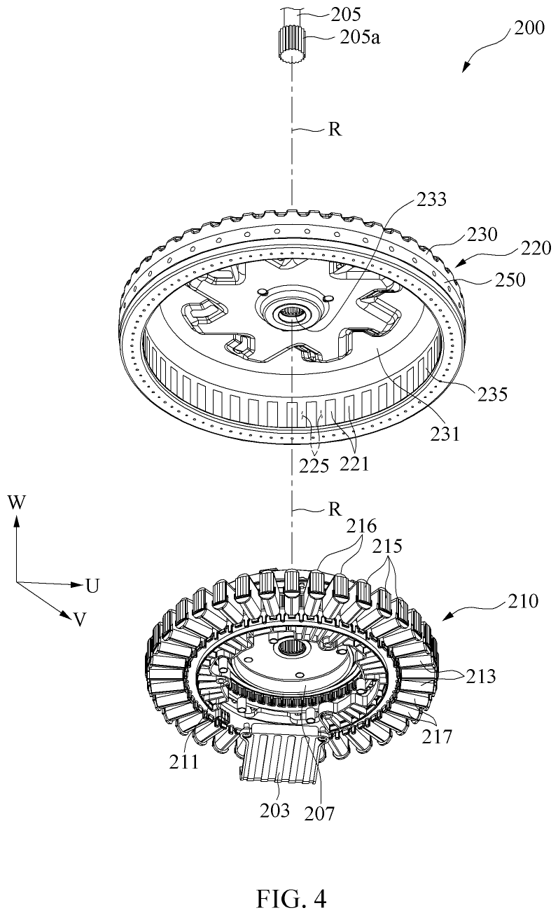

In an embodiment, the drum 20 may be rotatable about a rotation axis 112a (e.g., a shaft 205 in FIG. 4). A revolutions per minute (RPM) of the drum 20 may vary depending on the use of the clothing processing device 100, a cycle in progress, and the performance of the motor assembly 112. For example, the drum 20 may rotate 1000 to 3000 times per minute. The motor assembly 112 and the rotation axis 112a of a driving unit 110 for rotating the drum 20 may be installed in the rear portion of the tub 15. The tub 15 may further include a suspension device (not shown) to attenuate vibration generated when the drum 20 is driven to rotate. When the drum 20 is rotated by the motor assembly 112, dirt or contaminants from the laundry loaded in the drum 20 may be removed from the laundry through friction with the water stored in the tub 15.

In an embodiment, a spray nozzle 17 may be formed in an inlet area 21 of the tub 15, and the spray nozzle 17 may be connected to the water supply pipe 30 to supply washing water into the drum 20. The drainpipe 40 for draining washing water may be connected to one side of the bottom of the tub 15. The washing water described herein may be general water, but may also refer to a mixture containing detergent or contaminants in addition to water.

In an embodiment, the rear portion 20b of the drum 20 may be coupled to the rotation axis 112a of the driving unit 110 installed on the rear portion of the tub 15. The drum 20 may receive power (e.g., a rotational force) generated from the motor assembly 112 of the driving unit 110 through the rotation axis 112a to rotate along an axial direction of the rotation axis 112a.

In an embodiment, the clothing processing device 100 may include the water supply pipe 30 for supplying water to the tub 15 and the drum 20. The water supply pipe 30 may be connected to the external water supply pipe 3 of a faucet and may include a water supply valve 113 that opens and closes the water supply pipe 30. The water supply pipe 30 may be a flow path that connects the external water supply pipe 3 and the tub 15 or the drum 20 to supply washing water from the external water supply pipe 3 to the tub 15 or the drum 20. The water supply pipe 30 may be formed as a pair to supply cold water and hot water.

In an embodiment, a detergent receiving portion 14 may supply detergent to the drum 20, and the detergent may be transferred to the drum 20 by the water supply pipe 30. For example, the water supply pipe 30 may supply the washing water supplied from the external water supply pipe 3 and the detergent filled in the detergent receiving portion 14 together with the washing water, to the inside of the drum 20 via the detergent receiving portion 14 The detergent receiving portion 14 may include a detergent supply valve (e.g., a detergent supply valve 118 in FIG. 3) that opens and closes the detergent receiving portion 14 and a second water supply pipe 32 connecting the detergent receiving portion 14 and the drum 20 to control detergent supplied to the drum 20.

In an embodiment, the drainpipe 40 may refer to a flow path that connects the tub 15 and the external drainpipe 4 to drain washing water filled in the drum 20 into the external drainpipe 4. The drainpipe 40 may be connected to a pump 115 that allows the washing water in the drum 20 to flow and a drain valve 114 that is opened and closed to drain or maintain the washing water in the drum 20. A processor 140 may control the pump 115 and the drain valve 114 to control the washing water in the drum 20 to be drained to the outside or circulated back to the drum 20. When it controls the drain valve 114 to be closed and the pump 115 to be driven to circulate the washing water, the washing water in the drum 20 may have increased fluidity and may thus be evenly distributed to laundry, which may improve washing performance.

In an embodiment, the driving unit 110 may drive the overall operation of the clothing processing device 100. The driving unit 110 may rotate the drum 20 or a pulsator (not shown) and drive a heat exchanger 190 or a heater 116. The clothing processing device 100 may receive an input signal from the user and perform a plurality of unit cycles through the driving unit 110. The plurality of unit cycles may include a water supply cycle, a washing cycle, a rinsing cycle, a dewatering cycle, or a draining cycle.

FIG. 3 is a block diagram illustrating a configuration of the clothing processing device 100 according to an embodiment of the present disclosure.

Referring to FIG. 3, the clothing processing device 100 may include at least some of a driving unit 110, a sensor unit 120, and a processor 140.

In an embodiment, the clothing processing device 100 may be combined with at least one configuration or feature of the previously described embodiments unless clearly technically impossible.

In an embodiment, the driving unit 110, which is a component for performing an overall mechanical operation of the clothing processing device 100, may perform operations under the control of the processor 140. The driving unit 110 may include a power supply device 111 and a motor assembly 112, and may rotate a drum (e.g., the drum 20 in FIG. 2) of the clothing processing device 100.

In an embodiment, the power supply device 111 may be a device that provides power to the motor assembly 112 and controls the speed and torque of the motor assembly 112. The power supply device 111 may control the speed of the motor assembly 112 according to a control signal from the processor 140, and the power supply device 111 may control the speed of the motor assembly 112 using a voltage control method or a frequency conversion method.

In an embodiment, the power supply device 111 may be controlled by an intelligent power module (IPM) configured as a switching device. The IPM, a power supply module with a protection function added to protect a power device or driving circuit, may prevent the power supply device 111 and the components of the clothing processing device 100 from being damaged by overheating due to an increase in loads, for the power supply device 111 controlling the motor assembly 112.

In an embodiment, the motor assembly 112 may rotate the drum 20. The motor assembly 112 may refer to a prime mover that converts externally applied energy (e.g., electric power) into dynamic energy. For example, the motor assembly 112 may transfer dynamic energy to a shaft (e.g., a shaft 205 in FIG. 4) that is a rotation axis (e.g., the rotation axis 112a in FIG. 2), and the shaft 205 may transfer the dynamic energy transferred from the motor assembly 112 to the drum 20 to rotate the drum 20 in combination with the motor assembly 112 and the drum 20. The structure of the motor assembly 112 according to embodiments of the present disclosure will be described in detail below with reference to FIG. 4 and subsequent drawings.

In an embodiment, the driving unit 110 may include at least some of a water supply valve 113, a drain valve 114, a pump 115, a water jet 117, and a detergent supply valve 118.

In an embodiment, the water supply valve 113 may be opened and closed to supply or block washing water into the drum 20 under the control of the processor 140. The water supply valve 113 may be implemented as a solenoid valve or electromagnetic valve that may be opened and closed by a movement of a coil according to an applied current.

In an embodiment, the water supply valve 113 may be installed between an external water supply pipe (e.g., the external water supply pipe 3 in FIG. 2) and a water supply pipe (e.g., the water supply pipe 30 in FIG. 2) of the clothing processing device 100. The water supply pipe 30 of the clothing processing device 100 may connect the external water supply pipe 3 and the drum 20, and when the water supply valve 113 is in an on state, washing water may be supplied to the inside of the drum 20 along the water supply pipe 30. That is, the water supply valve 113 may control the washing water to be supplied or blocked from the external water supply pipe 3 to the inside of the drum 20 according to a state (e.g., on or off state) of the water supply valve 113.

For example, the water supply pipe 30 may include a first water supply pipe 31 connecting the external water supply pipe 3 and a detergent receiving portion (e.g., the detergent receiving portion 14 in FIG. 2) and a second water supply pipe (e.g., the second water supply pipe 32 in FIG. 2) connecting the detergent receiving portion 14 and the drum 20. The washing water supplied from the external water supply pipe 3 may pass through the detergent supply valve 118 and the detergent receiving portion 14, and may be supplied to the inside of the drum 20 together with detergent filled in the detergent receiving portion 14.

In an embodiment, the drain valve 114 may be opened and closed under the control of the processor 140 to drain or maintain the washing water filled inside the drum 20. The drain valve 114 may be implemented as a solenoid valve or an electromagnetic valve that may be opened and closed by a movement of a coil according to an applied current.

In an embodiment, the drain valve 114 may be installed between a drainpipe (e.g., the drainpipe 40 in FIG. 2) of the clothing processing device 100 and an external drainpipe (e.g., the external drainpipe 4 in FIG. 2). In this case, the drainpipe 40 of the clothing processing device 100 may connect the drum 20 and the external drainpipe 4, and when the drain valve 114 is in an on state, the washing water filled in the drum 20 may be drained into the external drainpipe 4 along the drainpipe 40. That is, the drain valve 114 may control the washing water to be drained from the inside of the drum 20 into the external drainpipe 4 or be maintained according to a state (e.g., on or off state) of the drain valve 114.

In an embodiment, the pump 115 may discharge the washing water filled in the drum 20 to the external drainpipe 4 using power or pressure under the control of the processor 140. To this end, the pump 115 may be installed between the drainpipe 40 and the external drainpipe 4.

In an embodiment, the pump 115 may include a shaft (not shown) including an impeller (not shown), an electric motor (not shown) mechanically connected to the shaft, a suction pipe (not shown) connected to the drainpipe 40, and a discharge pipe connected to the external drainpipe 4. When the drain valve 114 is in the on state and the impeller is rotated by the electric motor of the pump 115, the washing water in the drum 20 may pass through the suction pipe and the discharge pipe to be forcibly discharged into the external drainpipe 4. In addition, the processor 140 may circulate the washing water in the drum 20 by driving the pump 115 when the drain valve 114 is in the off state.

In an embodiment, a heater 116 may heat the washing water filled in the drum 20 to boil laundry or clean the drum 20. In an embodiment, when power is applied under the control of the processor 140, the heater 116 may convert applied electrical energy into thermal energy to heat the washing water in the drum 20.

In an embodiment, the water jet 117 may include a water jet pump (not shown) and a nozzle (not shown), and may spray the inflow washing water at a high pressure through the nozzle using the water jet pump (not shown). In this case, it may spray the washing water at a specific position inside the drum 20 to remove containments remaining inside the drum 20. In this case, the water jet 117 may be implemented as a separate device from the spray nozzle 17 for supplying washing water into the drum 20, or the water jet 117 may also be implemented as a single device integrated with the spray nozzle 17.

In an embodiment, the detergent supply valve 118 may open and close the detergent receiving portion 14 to automatically control the detergent to be supplied to the inside of the drum 20. The clothing processing device 100 may be implemented to include a detergent supply device (not shown) including the detergent supply valve 118, the detergent receiving portion 14, or a detergent sensor (not shown). The detergent supply device (not shown) may receive and store a predetermined amount of detergent, and when the processor 140 calculates a required amount of detergent after the clothing processing device 100 is driven, may open the detergent supply valve 118 and automatically provide a predetermined amount of detergent to the drum 20. Therefore, the user may conveniently supply an appropriate amount of detergent using such a supply device (not shown) without having to measure and add detergent each time the clothing processing device 100 is driven.

In an embodiment, the heat exchanger 190 may condense or expand a refrigerant to dry or heat the air passing through the heat exchanger 190, and provide a high-temperature dried gas to the drum 20.

In an embodiment, the cleaning device 195 may clean internal components of the clothing processing device 100, such as, a filter, a nozzle, or the heat exchanger 190. The cleaning device 195 may prevent aging or performance deterioration of the internal components due to a long-term use of the clothing processing device 100.

In an embodiment, the sensor unit 120 may sense an operating state or surrounding environment of the clothing processing device 100 and may generate and output an electrical signal in response to a sensing result obtained by the sensing. The sensor unit 120 may transmit the electrical signal to the processor 140 or store the sensing result in a memory 150 of the clothing processing device 100 or an external device.

For example, the sensor unit 120 may sense the operating state or surrounding environment of the clothing processing device 100 during a cleaning course to generate an electrical signal or obtain data, and the processor 140 may process the signal or data received from the sensor unit 120 to obtain diagnostic information.

In an embodiment, sensors included in the sensor unit 120 may be implemented as separate or physically separate devices or may be implemented as a single device. That is, the sensor unit 120 is not limited to being implemented as a single physical device. The sensor unit 120 may transfer a sensing value to the processor 140. The processor 140 may then control the operation of the clothing processing device 100 based on the received sensing value, store the sensing value as the diagnostic information in the memory 150, or transmit it to an external device (e.g., a server, a smartphone, etc.) through a communication interface 160 to store it in the external device.

In an embodiment, the sensor unit 120 may include at least some of a speed sensor 120-1, a weight sensor 120-2, and a temperature sensor 120-3.

In an embodiment, the speed sensor 120-1 may detect a rotation speed, a rotation angle, and a rotation direction of the motor assembly 112 or the drum 20. The processor 140 may calculate the rotation speed, the rotation angle, and the rotation direction of the motor assembly 112 or the drum 20 detected by the speed sensor 120-1 and control the operation of the clothing processing device 100 based on these.

In an embodiment, the speed sensor 120-1 may be implemented as a sensor using a method of detecting the size of a load applied onto the motor assembly 112 when the motor assembly 112 rotates the drum 20, a method of detecting an on/off signal of a Hall sensor adjacent to a position of a rotor of the motor assembly 112 while the rotor is rotating, or a method of measuring the size of current applied to the driving unit 110 or the motor assembly 112 while the drum 20 is rotating.

In an embodiment, the weight sensor 120-2 may detect the weight of the drum 20. In addition, when laundry is present inside the drum 20, the weight sensor 120-2 may detect the weight of the laundry and the drum 20, and in this case, may detect the weight of the laundry received in the drum 20 by estimating, as the weight of the laundry, a difference between the detected weight and the stored weight of the drum 20.

In an embodiment, the weight sensor 120-2 may detect the weight of the drum 20 by rotating the drum 20 in which no laundry is present to obtain the detected weight as diagnostic information. In this case, the weight sensor 120-2 may detect the weight of the drum 20 by estimating an inertia moment from the rotation speed and the rotation angle of the motor assembly 112 or the drum 20 detected through the speed sensor 120-1 and estimating the weight corresponding to the inertia moment.

In an embodiment, when the weight of the drum 20 is applied to a load cell and the shape of the load cell is changed, the weight sensor 120-2 may detect the magnitude of voltage based on the changed shape and estimate the weight of the drum 20 corresponding to the magnitude of voltage, and in such ways, various sensors may be implemented.

In an embodiment, the temperature sensor 120-3 may be an external temperature sensor that detects the temperature of an environment around the clothing processing device 100, or an internal temperature sensor that detects the temperature inside the clothing processing device 100 including, for example, the temperature of washing water in the tub 15, the temperature of the heater 116, and the temperature of the power supply device 111.

In an embodiment, the temperature sensor 120-3 may be implemented as a thermistor, a type of resistor using the property that the resistance of a material changes depending on the temperature. In this case, the thermistor may have a negative temperature coefficient (NTC) characteristic that the resistance decreases as the temperature increases and the resistance increases as the temperature decreases.

In an embodiment, the temperature sensor 120-3 may be a temperature sensor that detects the temperature of the heater 116 or washing water. The temperature sensor 120-3 may further include a temperature control device (e.g., a thermostat), and the temperature control device may detect an amount of heat generated in the heat exchanger 190 and control the temperature of the washing water or the drum 20 to be maintained at a specific temperature by the heat generated in the heater 116.

In an embodiment, the sensor unit 120 is not limited to the configuration described above, but may further include at least one of a water level sensor that detects the water level or flow rate of washing water, a detergent sensor that detects the type or remaining amount of detergent, a water leak sensor that detects water leakage of washing water, a humidity sensor that detects the humidity in the air, a turbidity sensor that detects the turbidity of washing water, a door sensor that detects whether the door 12 is opened or closed, a vibration sensor that detects the degree to which the clothing processing device 100 vibrates, and a valve sensor that detects the operation of the water supply valve 113 or the drain valve 114.

In an embodiment, the sensor unit 120 may detect the weight of the drum 20, whether the water supply valve 113 for supplying washing water is malfunctioning, the temperature of washing water, the flow rate of washing water supplied to the drum 20, whether the motor assembly 112 is malfunctioning, whether the drain valve 114 for draining washing water is malfunctioning, the flow rate of washing water drained from the drum 20, or the vibration of the clothing processing device 100. Therefore, the sensor unit 120 may contribute to improving the laundering cycle and washing performance of the clothing processing device 100 and may detect whether the clothing processing device 100 is operating normally or abnormally.

In an embodiment, a display 130 may display, in a display area, the diagnostic information obtained through the sensor unit 120 under the control of the processor 140. The display 130 may be disposed on the front of a housing of the clothing processing device 100, and the user may thus check an operating state of the clothing processing device 100. Alternatively, the display 130 may be implemented as an external one rather than built into the clothing processing device 100, and image data may be displayed on the external display connected to the clothing processing device 100 by wire or wirelessly.

In an embodiment, the processor 140 may control the overall operation of the clothing processing device 100. To this end, the processor 140 may include at least some of a random-access memory (RAM), a read-only memory (ROM), a graphics processing unit (GPU), a main central processing unit (CPU), first to nth interfaces, or a bus.

In an embodiment, when a user command is received, the processor 140 may operate the driving unit 110 based on an input signal and may perform a laundering cycle step by step. While the clothing processing device 100 is driven, the sensor unit 120 may detect the operating state of the clothing processing device 100, and based on this, the processor 140 may feed the operation state of the clothing processing device 100 back, or obtain and display the diagnostic information on the display 130.

In an embodiment, the memory 150 may store various instructions, programs, or data necessary for the operation of the clothing processing device 100 or the processor 140. The memory 150 may store information obtained by the sensor unit 120 and data received from an external electronic device.

In an embodiment, the memory 150 may be accessed by the processor 140, and the data may be read/written/modified/deleted/updated by the processor 140. Therefore, in describing the present disclosure, the term “memory” may include the memory 150, a RAM or a ROM in the processor 140, or a memory card provided in the clothing processing device 100.

In an embodiment, the memory 150 may be implemented as a volatile memory such as a static random-access memory (SRAM) and a dynamic random-access memory (DRAM), a non-volatile memory such as a flash memory, a ROM, an erasable programmable read-only memory (EPROM), an electrically erasable programmable read-only memory (EEPROM), a hard disk drive (HDD), or a solid-state drive (SSD).

In an embodiment, the processor 140 and the memory 150 may be implemented as physically separate components or may be implemented as a single component in which the processor 140 includes the memory 150. In addition, the processor 140 may be implemented as a single system with a single component or a single system with a plurality of components. The memory 150 may also be implemented as a single system with a single component or a single system with a plurality of components.

In an embodiment, the communication interface 160 may transmit and receive various types of data by communicating with an external device (e.g., a server, a smartphone, etc.) according to various types of communication methods. For example, the communication interface 160 may transmit information obtained by the sensor unit 120 to a server (or smartphone) or receive a control command for operating the clothing processing device 100 from the server (or smartphone).

In an embodiment, the communication interface 160 may include at least one of a Bluetooth chip, a Wi-Fi chip, a wireless communication chip, and a near-field communication (NFC) chip that perform wireless communication, and an Ethernet module and a universal serial bus (USB) module that perform wired communication. In this case, the Ethernet module or USB module that performs wired communication may communicate with an external device through an input/output port.

In an embodiment, an input interface 170 may be configured to receive various types of user commands from the user and transmit the received user commands to the processor 140. To this end, the input interface 170 may include an input device 13 such as a touch panel or key, a plurality of operation buttons, and a rotary lever.

In an embodiment, a speaker 180 may be built into the clothing processing device 100 and may directly output, as sound, various audio data obtained by various processing operations performed by an audio processing unit (not shown), such as, decoding, amplification, and noise filtering, or various notification sounds or voice messages.

Hereinafter, a cleaning course of the clothing processing device 100 will be briefly described in relation to the structure of the clothing processing device 100 and the operation of the processor 140 described above.

In an embodiment, when a user command for managing the clothing processing device 100 is received, the processor 140 may supply washing water to the drum 20 in a water supply cycle. Specifically, the processor 140 may control the water supply valve 113 to open by changing the water supply valve 113 from an off state to an on state, thereby supplying the washing water to the drum 20.

In this case, the processor 140 may adjust an amount of washing water to be supplied to the drum 20 by adjusting a time for which the water supply valve 113 is maintained in the on state. In this case, an amount of washing water to be supplied in the cleaning course may be determined based on the capacity of the drum 20. For example, the amount of washing water to be supplied in the cleaning course may be determined as a maximum amount that the drum 20 may accommodate or as an amount of a preset ratio. In addition, the processor 140 may adjust the temperature of washing water supplied to the drum 20 by adjusting the time for maintaining the on state of the water supply valve 113 for cold water and hot water. The processor 140 may adjust the temperature of the washing water by driving the heater 116.

In an embodiment, when a preset amount of washing water is supplied to the drum 20, the processor 140 may control the water supply valve 113 to be closed by changing the water supply valve 113 from the on state to the off state, and may thereby stop the supply of washing water. When the supply of washing water is stopped and a water supply cycle is completed, the processor 140 may control the driving unit 110 to rotate the drum 20 filled with the washing water during a cleaning cycle.

In an embodiment, the processor 140 may apply, to the power supply device 111, a control signal for rotating the drum 20 filled with the washing water by the motor assembly 112 of the driving unit 110, and the power supply device 111 may rotate the motor assembly 112 according to the applied control signal and transmit a rotational force to the drum 20 to rotate the drum 20. In addition, to remove contaminants attached to the drum 20 and laundry, the processor 140 may control the water jet 117 to spray high-temperature and high-pressure washing water. When the cleaning cycle is completed, the processor 140 may drain the washing water filled in the drum 20 in a draining cycle. Specifically, the processor 140 may control the drain valve 114 to be opened by changing the drain valve 114 from an off state to an on state, thereby allowing the washing water filled in the drum 20 to be drained to the outside. The processor 140 may also control the pump 115 to discharge the washing water filled in the drum 20 to the external drainpipe 4 using power or pressure.

In an embodiment, the processor 140 may control the driving unit 110 to rotate the drum 20 in a dewatering cycle. The power supply device 111 may drive the motor assembly 112 according to the applied control signal and transmit a rotational force to the drum 20 to rotate the drum 20. The control signal, which is a signal for driving the motor assembly 112 step by step, may be used to drive the motor assembly 112 at a decelerated, accelerated, or maintained rotation speed according to time.

In the embodiment described above, although the draining cycle and the dewatering cycle are performed separately, they may be part of various cycles, and the draining cycle and the dewatering cycle may be performed simultaneously, or the draining cycle may be performed after the dewatering process.

FIG. 4 is an exploded perspective view of a motor assembly 200 according to an embodiment of the present disclosure.

Referring to FIG. 4, according to an embodiment, the motor assembly 200 (e.g., the motor assembly 112 in FIGS. 2 and 3) may include a stator 210 and a rotor 220.

In an embodiment, the motor assembly 200 may be combined with at least one configuration or feature of the previously described embodiments unless clearly technically impossible.

In an embodiment, the motor assembly 200 may be a permanent magnet synchronous motor (PMSM) in which the rotor 220 includes permanent magnets 225. In an embodiment, the motor assembly 200 may include the stator 210 and the rotor 220. The motor assembly 200 may generate power by an electromagnet interaction between a coil 217 disposed to surround the stator 210 and the permanent magnets 225 disposed in the rotor 220.

For example, when a current is applied to the coil 217, the coil 217 and the plurality of permanent magnets 225 may interact electromagnetically to rotate the rotor 220, and a shaft 205 may connect the rotor 220 and an external device to allow the motor assembly 200 to generate power for rotating the external device. Hereinafter, a drum (e.g., the drum 20 in FIGS. 1 and 2) of a clothing processing device (e.g., the clothing processing device 100 in FIGS. 1 to 3) will be described as an example of the external device to which the motor assembly 200 transfers power, but the actual implementation is not limited thereto, and the external device may be implemented using various devices such as a fan (not shown) or a wheel (not shown).

In an embodiment, the motor assembly 200 may be an outer-rotor type motor assembly 200 in which the stator 210 is disposed at the center and the rotor 220 is disposed to surround the stator 210 to be rotated. Compared to an inner-rotor type, the outer-rotor type motor assembly 200 may have a relatively larger diameter in a circumferential direction of the rotor 220 and may have a higher torque density and power density.

In an embodiment, the stator 210 may have an annular structure, and the stator 210 may include a center area 211 adjacent to a rotation axis R (e.g., the rotation axis 112a in FIG. 2) and a plurality of tooth areas 213 extending in a direction (e.g., a U-V plane direction) parallel to the rotation axis R form the center area 211.

In an embodiment, a clutch module 207 may be coupled to the center area 211 of the stator 210, and the plurality of tooth areas 213 may each include a stator core 215, an insulator 216 covered with the stator core 215, and a coil 217 wound around the insulator 216 in a direction surrounding the stator core 215.

In an embodiment, the insulator 216 may support various components of the stator 210 and may be formed of an insulating material to prevent a current loss. In an embodiment, the coil 217 may be implemented in a form that a conductive wire is repeatedly wound around an outer circumferential surface of the stator core 215, or the coil 217 may be implemented in a form that a conductive plate surrounds the stator core 215.

In an embodiment, a partial area of the insulator 216 may be opened to expose the stator core 215 in an area corresponding to the outer circumferential surface of the plurality of tooth areas 213 in one direction opposite to the rotation axis R. The area where the stator core 215 is exposed may face the permanent magnets 225 of the rotor 220 at a predetermined interval.

In an embodiment, a power supply unit 203 may receive power from an external source (e.g., the power supply device 111 in FIG. 2) and apply a current to the coil 217. In an embodiment, the coil 217 may be formed with a three-phase coil group, and the power supply unit 203 may apply a current in an alternating current (AC) form to the coil 217 to allow the coil 217 and the rotor 220 to electromagnetically interact with each other to generate an electromagnetic force.

In an embodiment, the rotor 220 may include a rotor frame 230, a plurality of cores 221, and the plurality of permanent magnets 225. The rotor frame 230 may be provided in a cylindrical shape that accommodates therein the stator 210 and has an open interior so as to rotate around the rotation axis R. For example, the rotor frame 230 may be centered on the rotation axis R and may include a bottom surface 231 on which a serration 233 to which the shaft 205 is to be connected is disposed, and a side wall 235 extending to surround the rotor 220 in the circumferential direction from the circumference of the bottom surface 231.

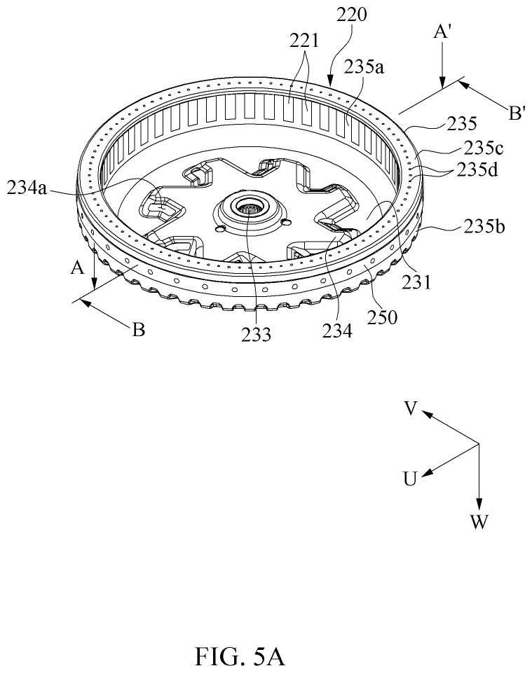

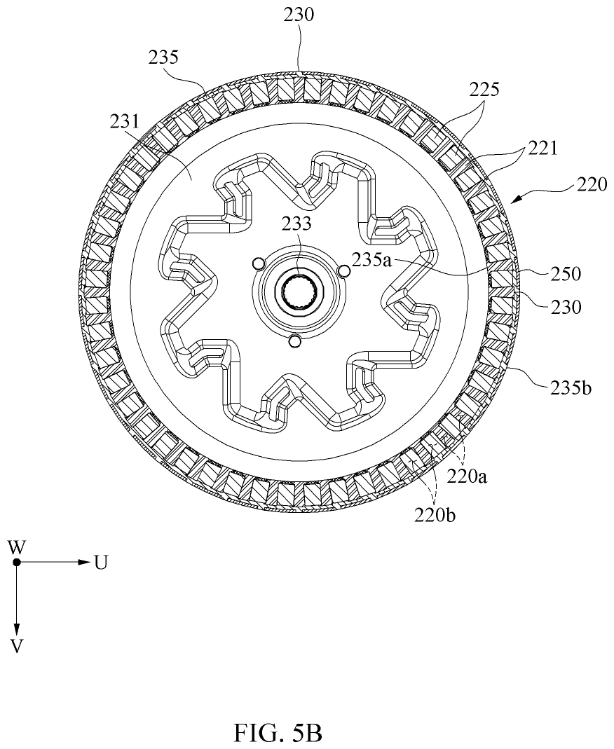

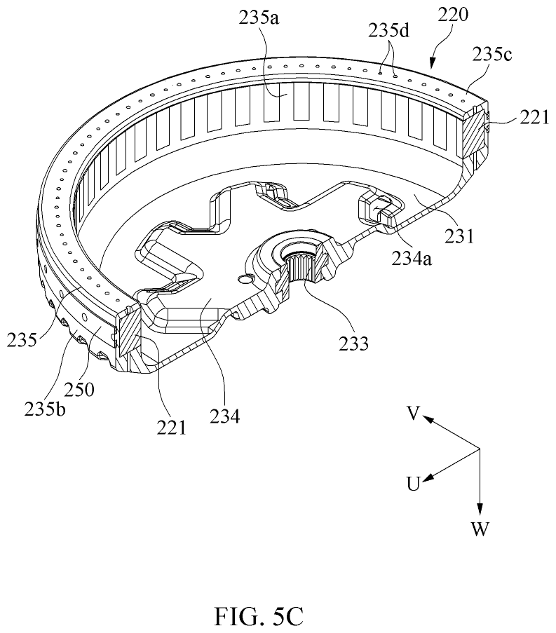

In an embodiment, the plurality of cores 221 and the plurality of permanent magnets 225 may be disposed inside the side wall 235 of the rotor frame 230 to be supported by the rotor frame 230. The plurality of permanent magnets 225 may be arranged to face the stator core 215 of the stator 210 and may electromagnetically interact with the coil 217 and the stator core 215 of the stator 210. In an embodiment, an outer ring 250 may be disposed to surround the rotor frame 230. The rotor 220 and the outer ring 250 will be described in greater detail below with reference to FIG. 5A and subsequent drawings.

In an embodiment, the shaft 205 may rotate around the rotation axis R of the motor assembly 200 and may transfer power to the drum 20. For example, the shaft 205 may be coupled to a rear portion of the drum 20 (e.g., the rear portion 20b in FIG. 2) and transfer power resulting from the driving of the motor assembly 200 to the drum 20 rotate the drum 20.

In an embodiment, when the clothing processing device 100 includes a pulsator (not shown), the drum 20 may include the pulsator (not shown) installed on the bottom of the interior and coupled to the shaft 205, and the motor assembly 200 may transfer power to the pulsator (not shown) through the shaft 205 to rotate the pulsator (not shown).

In an embodiment, the clutch module 207 may include at least some of a clutch and a reduction gear module between the rotor frame 230 and the stator 210. In an embodiment, the clutch module 207 may change a connection state of the reduction gear module and the motor assembly 200 by driving the clutch. The clutch module 207 may change a rotation state, for example, a rotation speed or rotation torque, of the shaft 205 in the motor assembly 200 including the single shaft 205.

The structure and operation of the motor assembly 200 described above are provided for illustrative purposes to implement the motor assembly 200 according to an embodiment of the present disclosure, but examples of actual implementation are not limited thereto, and the configuration and operations of the components of the motor assembly 200 may be implemented in various ways.

FIG. 5A is a perspective view of the rotor 220 according to an embodiment of the present disclosure, FIG. 5B is a cross-sectional view of the rotor 220 according to an embodiment of the present disclosure, and FIG. 5C is a cross-sectional perspective view of the rotor 220 according to an embodiment of the present disclosure.

Specifically, FIG. 5B is a cross-sectional view of the rotor 220 viewed in one direction (e.g., a +W direction) based on a line A-A′ shown in FIG. 5A, and FIG. 5C is a cross-sectional perspective view of the rotor 220 viewed in one direction (e.g., a −V direction) based on a line B-B′ shown in FIG. 5A.

Referring to FIGS. 5A to 5C, according to an embodiment, the rotor 220 may include at least some of a rotor frame 230, a serration 233, a plurality of cores 221, a plurality of permanent magnets 225, and an outer ring 250.

In an embodiment, the rotor 220 may be combined with at least one configuration or feature of the previously described embodiments unless clearly technically impossible.

In an embodiment, the rotor frame 230 may be a housing that accommodates therein and supports at least some of the serration 233, the plurality of permanent magnets 225, and the plurality of cores 221. In an embodiment, the rotor frame 230 may be formed as a single body by being molded and injected with internal components arranged therein.

In an embodiment, the rotor frame 230 may be formed to accommodate a stator (e.g., the stator 210 in FIG. 4) therein. The rotor frame 230 may include a bottom surface 231 with a rotation axis R at a center thereof and a side wall 235 extending in one direction (e.g., a −W direction or first direction) to surround the rotor 220 in a circumferential direction from the circumference of the bottom surface 231. For example, the rotor frame 230 may be provided in a cylindrical shape with one side open such that the rotor 220 is coupled thereto, or the rotor frame 230 may be provided in an annular structure in which the side wall 235 extends in the circumferential direction based on the bottom surface 231.

In an embodiment, the side wall 235 of the rotor frame 230 may include an inner surface 235a facing a direction of the rotation axis R or a center direction, an outer surface 235b opposite the inner surface 235a, and an upper surface 235c connected from the inner surface 235a to the outer surface 235b. In an embodiment, the upper surface 235c may be formed with a plurality of molded holes 235d. The plurality of molded holes 235d may be opened from the upper surface 235c through at least a portion of the side wall 235, and the plurality of molded holes 235d may be formed by a pin member during an injection process of the rotor frame 230 and may be formed on the upper surface 235c corresponding to the positions of the plurality of cores 221.

In an embodiment, the serration 233 and a spoke 234 may be formed on the bottom surface 231 of the rotor frame 230, and the plurality of cores 221 and the plurality of permanent magnets 225 may be arranged on the side wall 235 of the rotor frame 230.

In an embodiment, the serration 233 may connect the shaft 205 and the rotor 220 such that the shaft 205 rotates in conjunction with the rotor 220. The serration 233 may have a cross-sectional structure corresponding to a cross-section of a connection area 205a of the shaft 205 such that the shaft 205 is fixed.

In an embodiment, the serration 233 may be formed on the bottom surface 231 of the rotor frame 230, and the shaft 205 may be coupled to the serration 233. In an embodiment, the shaft 205 may be connected to the rotor frame 230 in another direction (e.g., a +W direction or second direction) opposite to the first direction in which the side wall 235 extends. In an embodiment, the serration 233 may have a structure bent in a circumferential direction surrounding the rotation axis R. For example, the serration 233 may have a structure in which a plurality of saw-toothed cross sections each having a substantially triangular shape is consecutively connected.

In an embodiment, the spoke 234 may have a structure that is inclined while radiating in the circumferential direction around the serration 233. The spoke 234 may distribute an external force to prevent the rotor frame 230 from being damaged, and the spoke 234 may have a heat release hole 234a to release heat generated from the rotor 220 and the stator 210 into the outside of the motor assembly 200.

In an embodiment, the plurality of cores 221 and the plurality of permanent magnets 225 may be respectively disposed in insertion grooves 220a and 220b inside the side wall 235. For example, the side wall 235 may include a plurality of first insertion grooves 220a formed therein and a plurality of second insertion grooves 220b respectively disposed between the plurality of first insertion grooves 220a. The plurality of cores 221 may be formed in the plurality of first insertion grooves 220a, and the plurality of permanent magnets 225 may be formed in the plurality of second insertion grooves 220b.

In an embodiment, the plurality of first insertion grooves 220a and the plurality of second insertion grooves 220b may be arranged along the circumferential direction on the outside of the stator 210. In an embodiment, the plurality of second insertion grooves 220b may each be a space formed for a permanent magnet 225 to be disposed between the plurality of cores 221. In an embodiment, the first insertion grooves 220a and the second insertion grooves 220b may be spaces formed by arranging the plurality of cores 221 and the plurality of permanent magnets 225 inside a mold during an injection molding process for the rotor frame 230 and by injecting a material of the rotor frame 230 into the mold.

In an embodiment, the plurality of second insertion grooves 220b may be formed between the inner surface 235a and the outer surface 235b of the side wall 235 to be surrounded by the inner surface 235a and the outer surface 235b. The plurality of first insertion grooves 220a may be formed to be opened toward the inner surface 235a of the side wall 235 and closed toward the outer surface 235b.

In an embodiment, the plurality of cores 221 may stably support the plurality of permanent magnets 225 and improve an electromagnetic force generated by an electromagnetic interaction between the rotor 220 and the stator 210. In an embodiment, the plurality of cores 221 may be arranged on the side wall 235 along the circumferential direction.

In an embodiment, the plurality of cores 221 may each be a rotor core or a rotor core segment that is distinguished from the stator core 215. Hereinafter, for the convenience of description, a core 215 of the stator 210 will be referred to as a “stator core” 215, and a core 221 of the rotor 220 will be referred to as a “plurality of cores” 221 or a “core” 221.

In an embodiment, the plurality of cores 221 may be arranged to be spaced apart from each other in a circumferential direction surrounding the stator 210 to form the plurality of second insertion grooves 220b for arranging the plurality of permanent magnets 225 spaced apart from each other. For example, a second insertion groove 220b may be formed between two cores 221 spaced apart from each other, and at least one permanent magnet 225 may be disposed in the second insertion groove 220b.

In an embodiment, the plurality of permanent magnets 225 may be arranged on the side wall 235 along the circumferential direction and disposed respectively between the plurality of cores 221. The plurality of permanent magnets 225 may be arranged to be spaced apart from each other, and the plurality of cores 221 and the plurality of permanent magnets 225 may be arranged alternately with each other.

In an embodiment, the plurality of permanent magnets 225 may electromagnetically interact with the stator 210 to generate a magnetic force therefrom. In an embodiment, the plurality of permanent magnets 225 may have an arc shape radiating around the rotation axis R. The plurality of permanent magnets 225 may be arranged in the circumferential direction such that S poles and N poles are alternately arranged in a direction facing the rotor 220, in the plurality of second insertion grooves 220b.

In an embodiment, the electromagnetic force of the plurality of permanent magnets 225 may be formed in a circumferential direction surrounding the rotor 220. The electromagnetic force may rotate the rotor frame 230 in the circumferential direction around the rotation axis R. The serration 233 fixed to the rotor frame 230 may rotate the shaft 205, and the motor assembly 200 may rotate an external device connected to the shaft 205, for example, the drum 20.

In an embodiment, the outer ring 250 may be disposed on the outer surface 235b of the side wall 235 opposite from the center of the rotor frame 230 along the circumferential direction. The outer ring 250 may have a shape extending along the circumferential direction on the outer surface 235b of the rotor frame 230, and may have a substantially rectangular cross section in a vertical direction (e.g., the +/−W direction).

In an embodiment, the outer ring 250 may be formed to surround the plurality of cores 221 and/or the plurality of permanent magnets 225. The outer ring 250 may be disposed to be spaced apart from the plurality of cores 221 with the side wall 235 interposed therebetween. Alternatively, the outer ring 250 may be disposed to be spaced apart from the plurality of permanent magnets 225 with the side wall 235 interposed therebetween.

In an embodiment, the outer ring 250 may be a shatter-proof member that prevents the rotor frame 230 from shattering by fixing and supporting the plurality of cores 221 and/or the plurality of permanent magnets 225 with the side wall 235 interposed therebetween. The outer ring 250 may support the rotor frame 230 to prevent the rotor frame 230 from being damaged by a strong centrifugal force generated as the rotor frame 230 rotates.

In an embodiment, the outer ring 250 may be formed of a non-magnetic material. The outer ring 250 may not substantially form a magnetic field by an electromagnetic interaction between the rotor 220 and the stator 210, and prevent a magnetic flux from leaking, thereby preventing a power loss.

In an embodiment, the outer ring 250 may be disposed to be spaced apart from the plurality of cores 221 with the side wall 235 interposed therebetween, thereby reducing an eddy current loss of the motor assembly 200. In another embodiment, when the outer ring 250 and the plurality of cores 221 are closely connected, there may be an eddy current loss occurring by an eddy current flowing along the surface of the plurality of cores 221 because the outer ring 250 is formed of a non-magnetic material. In an embodiment, when the outer ring 250 is disposed at a predetermined distance from the plurality of cores 221, the eddy current loss occurring by the outer ring 250 may be reduced, and the power efficiency of the motor assembly 200 may thus be improved.

In an embodiment, the outer ring 250 may be disposed at a distance of substantially between 1 millimeter (mm) and 2 mm from at least some of the plurality of cores 221. For example, based on general profiling the eddy current loss of the motor assembly 200 installed in the clothing processing device 100, the eddy current loss of about 4 watts (W) or greater may occur when the distance between the outer ring 250 and the plurality of cores 221 is 0.5 mm or less, the eddy current loss may be reduced to about 2.5 W when the distance between the outer ring 250 and the plurality of cores 221 increases to 1 mm or greater, and the eddy current loss may be reduced to about 1 W when the distance between outer ring 250 and the plurality of cores 221 increases to 1.5 mm or greater. In an embodiment, the outer ring 250 may be spaced apart from the plurality of cores 221 at a distance of 1 mm to 2 mm, which may reduce the power loss due to the eddy current loss.

In an embodiment, the outer ring 250 may be disposed at a predetermined distance from the plurality of cores 221 and/or the plurality of permanent magnets 225 with the side wall 235 of the rotor frame 230 interposed therebetween. The outer ring 250 may thus prevent the rotor frame 230 from shattering and reduce the eddy current loss generated by the outer ring 250.

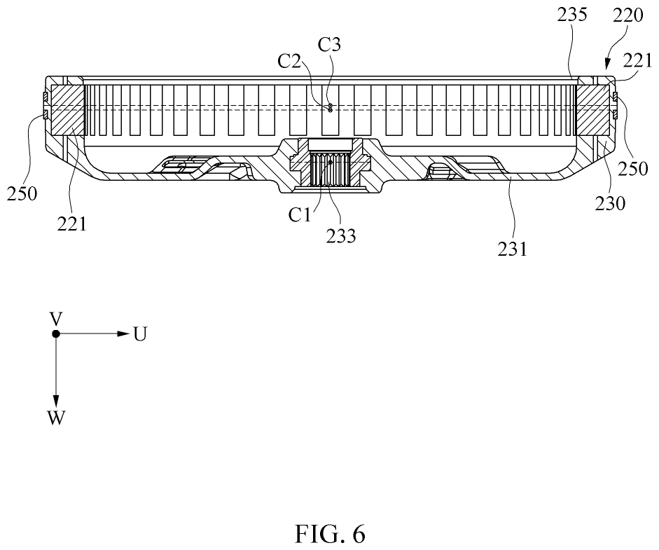

According to an embodiment of the present disclosure, the outer ring 250 and the rotor frame 230 may be interconnected and fixed with the side wall 235 interposed therebetween in various structures and methods, and example structures thereof will be described below with reference to FIG. 6.

FIG. 6 is a cross-sectional view of a partial area of the rotor 220 according to an embodiment of the present disclosure.

Referring to FIG. 6, according to an embodiment, a center of gravity (also referred to herein as a centroid) of the serration 233, a centroid of the plurality of cores 221, and a centroid of the outer ring 250 may be formed to be spaced apart from each other in a predetermined direction.

In an embodiment, the rotor 220 may be combined with at least one configuration or feature of the previously described embodiments unless clearly technically impossible.

In an embodiment, a centroid C1 of the serration 233, a centroid C2 of the plurality of cores 221, and a centroid C3 of the outer ring 250 may each be a virtual center point corresponding to the center of mass of each member. The plurality of centroids C1, C2, and C3 may be formed at a center position of the rotor frame 230 in a horizontal direction (e.g., a U-V plane direction) or at a position where the rotation axis R substantially penetrates, and may be formed to be spaced apart from each other in a vertical direction (e.g., a +/−W direction, or a first direction and a second direction).

In an embodiment, the centroid C1 of the serration 233 may be formed near the bottom surface 231 of the rotor frame 230 in the vertical direction, and the centroid C2 of the plurality of cores 221 and the centroid C3 of the outer ring 250 may be formed to be spaced apart from the centroid C1 of the serration 233 in one direction (e.g., the −W direction or first direction) in which the side wall 235 extends.

In an embodiment, the plurality of cores 221 may be disposed such that the centroid C2 of the plurality of cores 221 is spaced apart from the centroid C1 of the serration 233 in the first direction, and the outer ring 250 may be disposed such that the centroid C3 of the outer ring 250 is spaced apart from the centroid C2 of the plurality of cores 221 in the first direction.

In an embodiment, the plurality of centroids C1, C2, and C3 may be formed by sequentially rising from the bottom surface 231 of the rotor frame 230, and the outer ring 250 may be formed to prevent the rotor frame 230 from shattering.

For example, while the rotor frame 230 is rotating, a centrifugal force may act on the rotor frame 230 centered on the serration 233 that supports the shaft 205. In an embodiment, the plurality of cores 221 and the plurality of permanent magnets 225 may be spaced apart from the rotation axis R to be formed in the circumferential direction, and thus the centrifugal force may act relatively strongly. Alternatively, since the plurality of cores 221 and the plurality of permanent magnets 225 are fixed to the side wall 235 extending in one direction from the bottom surface 231, the centrifugal force may act in a direction receding from the centroid of the serration 233 which is the direction in which the side wall 235 extends.

According to an embodiment, to prevent shattering due to the centrifugal force, the outer ring 250 may be coupled to the outer surface 235b of the side wall 235 of the rotor frame 230 by rising in a direction opposite to the centroid C1 of the serration 233, i.e., in the first direction in which the side wall 235 extends, based on the centroid C2 of the plurality of cores 221, which is a direction in which centrifugal force acts. Therefore, shattering that may occur by the centrifugal force acting on the plurality of cores 221 and the plurality of permanent magnets 225 may be prevented.

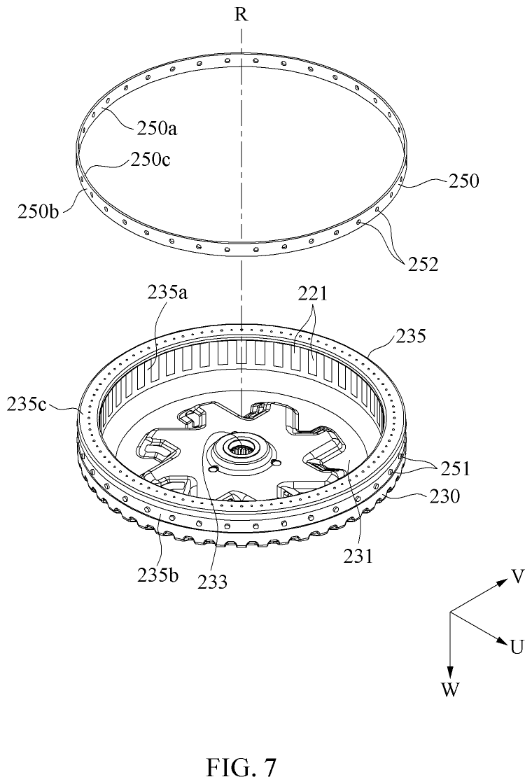

FIG. 7 is an exploded perspective view of the rotor 220 according to an embodiment of the present disclosure.

Referring to FIG. 7, according to an embodiment, the rotor frame 230 may include a locking member 251, and the outer ring 250 may include a locking groove 252.

In an embodiment, the rotor 220 may be combined with at least one configuration or feature of the previously described embodiments unless clearly technically impossible.

In an embodiment, the rotor frame 230 may include the locking member 251 protruding from the outer surface 235b of the side wall 235 to support the outer ring 250. The locking member 251 may be a protruding member that protrudes in a direction (e.g., a U-V plane direction) radiating from the rotor frame 230. The locking member 251 may have a circular or polygonal cross-sectional structure and may be formed integrally with the side wall 235 in an injection process of injecting the rotor frame 230.

In an embodiment, the outer ring 250 may include the locking groove 252 having a shape corresponding to the locking member 251 such that the locking member 251 is inserted therein. For example, the outer ring 250 may include a first surface 250a facing the rotor frame 230, a second surface 250b opposite to the first surface 250a, and a third surface 250c leading to the second surface 250b from the first surface 250a. The locking groove 252 may be formed on the first surface 250a to receive therein the locking member 251 protruding from the rotor frame 230.

In an embodiment, the locking groove 252 may have a structure corresponding to the locking member 251 in terms of various factors such as the size, shape, and extended length, and may have a structure that substantially matches the locking member 251. The locking groove 252 and the locking member 251 may be coupled so as to be in substantially close contact with each other and may thus stably fix and support the rotor frame 230 and the outer ring 250.

In an embodiment, the locking groove 252 may be a hole that penetrates to be opened from the first surface 250a which is one surface facing the rotor frame 230 to the second surface 250b which is the other surface in an opposite direction. Alternatively, in another embodiment, the locking groove 252 may be of a groove structure formed by being bent in a direction from the first surface 250a to the second surface 250b of the outer ring 250.

In an embodiment, the rotor frame 230 may include a plurality of locking members 251 arranged to be spaced apart in the circumferential direction, and the outer ring 250 may also include a plurality of locking grooves 252 arranged to correspond to respective positions of the plurality of locking members 251. The plurality of locking members 251 and the plurality of locking grooves 252 may be arranged such that one locking member 251 and one locking groove 252 form a pair, respectively. However, examples are not limited thereto, and the locking member 251 may be formed as one protruding area extending in the circumferential direction, and the locking groove 252 may be formed as one receiving groove corresponding thereto.

FIG. 7 provides an embodiment of the locking member 251 and the locking groove 252, and in actual implementation thereof, the position, shape, or size of the locking member 251 may be designed in various ways, and the locking groove 252 may be designed to be coupled to the locking member 251 correspondingly.

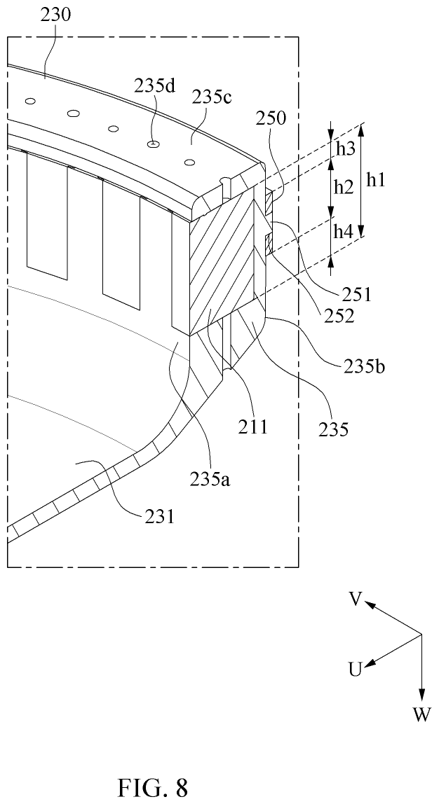

FIG. 8 is a cross-sectional perspective view of a partial area of the rotor 220 according to an embodiment of the present disclosure.

Referring to FIG. 8, the outer ring 250 may have a smaller size than the plurality of cores 221.

In an embodiment, the rotor 220 may be combined with at least one configuration or feature of the previously described embodiments unless clearly technically impossible.

Referring to FIG. 8, in an embodiment, the outer ring 250 may have a height h2 in a vertical direction (e.g., a +/−W direction or first direction), which is smaller than a height h1 of the plurality of cores 221 in the vertical direction. In an embodiment, the outer ring 250 may have a uniform or substantially equal height in a circumferential direction.

For example, when the height h1 of the plurality of cores 221 has a value between about 25 mm and 30 mm, the height h2 of the outer ring 250 may have a value between 13 mm and 16 mm.

In an embodiment, the outer ring 250 may be disposed at a predetermined distance upward from a center of the plurality of cores 221 in the vertical direction. In comparison between an upper height h3 which is a height from an upper end of the plurality of cores 221 to an upper end of the outer ring 250, and a lower height h4 which is a height from a lower end of the plurality of cores 221 to a lower end of the outer ring 250, the upper height h3 may have a smaller value than the lower height h4.

For example, in a case in which the height h1 of the plurality of cores 221 is 28 mm and the height h2 of the outer ring 250 is 15 mm, the upper height h3 may be approximately 4 mm, and the lower height h4 may be approximately 9 mm.

In an embodiment, the outer ring 250 may be fastened to a position relatively closer to the upper end than the lower end of the plurality of cores 221, such that the centroid (e.g., C3 in FIG. 6) of the outer ring 250 may be formed at a position raised upward in the vertical direction than the centroid (e.g., C2 in FIG. 6) of the plurality of cores 221, which may allow the outer ring 250 to effectively prevent the rotor frame 230 from shattering.

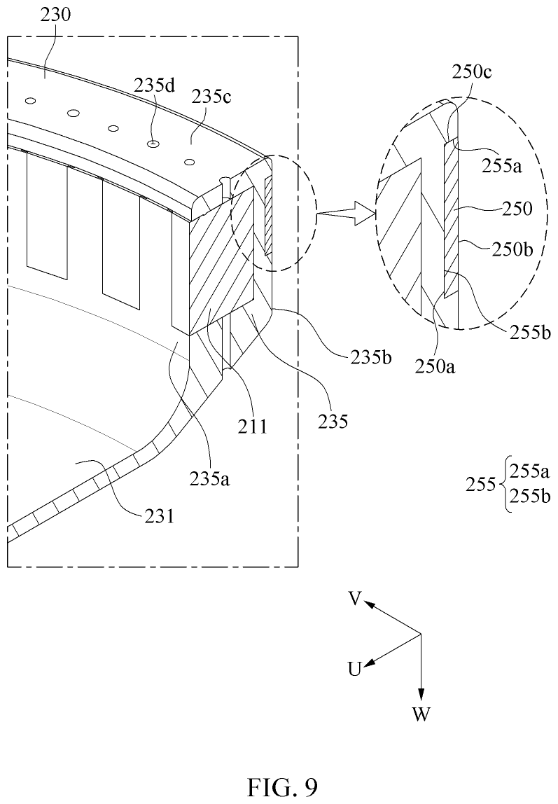

FIG. 9 is a cross-sectional perspective view of a partial area of the rotor 220 according to an embodiment of the present disclosure.

Referring to FIG. 9, according to an embodiment, the rotor frame 230 and the outer ring 250 may be fastened and fixed to each other in various ways.

In an embodiment, the rotor 220 may be combined with at least one configuration or feature of the previously described embodiments unless clearly technically impossible.

In an embodiment, the rotor frame 230 may include a seating groove 255 formed by being bent from the outer surface 235b toward a center of the rotor frame 230 to receive therein the outer ring 250. In an embodiment, the seating groove 255 may support the outer ring 250 in a vertical direction (e.g., a +/−W direction or first direction).

In an embodiment, the seating groove 255 may include a first bent area 255a formed by being bent from the outer surface 235b of the side wall 235 toward the inner surface 235a to face the third surface 250c of the outer ring 250, and a second bent area 255b formed by being bent from the first bent area 255a to face the first surface 250a of the outer ring 250. In an embodiment, the first bent area 255a may support the outer ring 250 in the vertical direction and may fix the outer ring 250 to prevent it from escaping by a centrifugal force acting in the vertical direction.

In an embodiment, the seating groove 255 may have a width corresponding to a width of the outer ring 250 in a horizontal direction (e.g., a U-V plane direction), and when the outer ring 250 is fastened to the seating groove 255, the outer surface 235b of the rotor frame 230 and the outer ring 250 may form a substantially flat surface. However, examples are not limited thereto, and the width of the seating groove 255 may be smaller than that of the outer ring 250, and at least a portion of the outer ring 250 may protrude from the outer surface 235b of the side wall 235 of the rotor frame 230.

In an embodiment, structures to which the outer ring 250 and the rotor frame 230 are fixed and fastened, such as, the locking member 251, the locking groove 252, and the seating groove 255, are provided only to illustrate how the outer ring 250 is fastened to the outer surface 235b of the rotor frame 230, and an actual implementation thereof is not limited thereto but changes or modifications in design that may be easily made by those skilled in the art, for example, combining the structures or omitting some of the structures, may be implemented.

For example, the locking member 251 may have a rectangular or oval cross-section extending in a vertical direction (e.g., the +/−W direction). Alternatively, the locking member 251 may protrude with a cross-sectional area decreasing from the outer surface 235b in an outward direction, and may have a triangular or oval cross section in the horizontal direction (e.g., the U-V plane direction).

For example, the motor assembly 200 may include a bonding member (not shown) applied between the outer ring 250 and the rotor frame 230 to support the outer ring 250, which may allow the outer ring 250 and the rotor frame 230 to be closely coupled to each other. The embodiment including the bonding member (not shown) may be applied to a method of fastening the outer ring 250 in a separate process after the rotor frame 230 is molded and injected. Since the bonding member (not shown) does not include a separate bent structure or groove structure in the rotor frame 230 and the outer ring 250, the outer ring 250 and the rotor frame 230 may be coupled such that their rigidity is evenly distributed over the entire area, which may simplify the structure of the rotor 220.

In another embodiment, the locking member 251 and the locking groove 252 may be formed at positions opposite to each other. For example, the outer ring 250 may include the locking member 251 protruding toward the rotor frame 230, and the rotor frame 230 may include the locking groove 252 receiving therein the locking member 251.

However, the locking member 251 and the locking groove 252 according to the embodiments of the present disclosure are not limited to the example implementation described above, and may be implemented in various structures for fastening the rotor frame 230 and the outer ring 250. For example, the locking member 251 may be a bracket, and the locking groove 252 may be a receiving groove of the bracket.

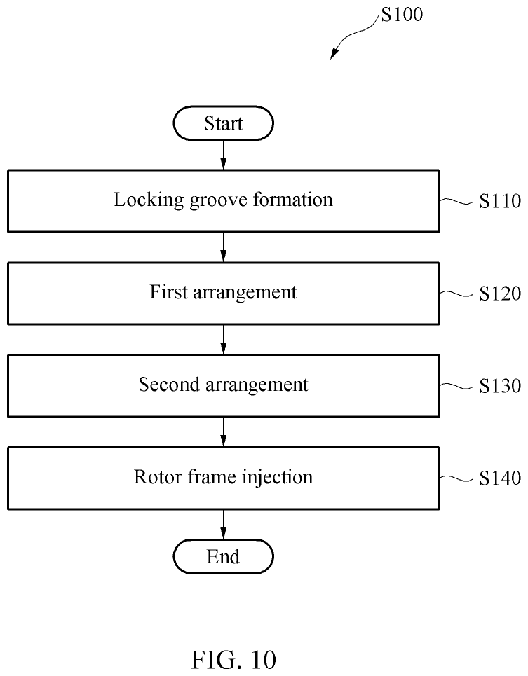

FIG. 10 is a flowchart illustrating a method of manufacturing the motor assembly 200 according to an embodiment of the present disclosure.

Referring to FIG. 10, a method S100 of manufacturing the motor assembly 200 may include forming the rotor frame 230 as a single body through molding and injection.

In an embodiment, at least one configuration or feature of the previously described embodiments may be combined in the method S100 of manufacturing the motor assembly 200 unless it is clearly technically impossible.

In an embodiment, the method S100 of manufacturing the motor assembly 200 may include at least some of operation S110 of forming the locking groove 252, first arrangement operation S120, second arrangement operation S130, and operation S140 of injecting the rotor frame 230.

In an embodiment, the operation S110 of forming the locking groove 252 may form the locking groove 252 in the outer ring 250. For example, the operation S110 of forming the locking groove 252 may perform a separate mold injection process using a mold including the locking groove 252 to inject the outer ring 250 such that it includes the locking groove 252. Alternatively, after the outer ring 250 is formed, a perforation process may be performed to form the locking groove 252.

In an embodiment, the first arrangement operation S120 may arrange the plurality of permanent magnets 225 and the plurality of cores 221 inside a cavity of the mold, and the second arrangement operation S130 may arrange the outer ring 250 inside the cavity to be spaced apart from the plurality of cores 221. In an embodiment, the first arrangement operation S120 and the second arrangement operation S130 may be performed sequentially or simultaneously, or the second arrangement operation S130 may be performed first to arrange the outer ring 250, and the first arrangement operation S120 may then be performed to arrange the plurality of cores 221 and the plurality of permanent magnets 225 to be spaced apart from the outer ring 250.

In an embodiment, the operation S140 of injecting the rotor frame 230 may inject a material into the cavity to form and inject the rotor frame 230 such that the side wall 235 is formed between the plurality of cores 221 and the outer ring 250 and the locking member 251 to be received in the locking groove 252 is formed on the side wall 235. In an embodiment, the operation S140 of injecting the rotor frame 230 may mold or form the rotor frame 230 by insert-injecting the plurality of cores 221, the plurality of permanent magnets 225, and the outer ring 250, and thus the motor assembly 200 may be formed such that the rotor frame 230 is implemented as a single body.

According to an embodiment, a motor assembly 200 may include a stator 210 and a rotor 220 that electromagnetically interacts with the stator 210 and rotates about a rotation axis R, in which the rotor 220 may include: a rotor frame 230 including a bottom surface 231 centered on the rotation axis R and a side wall 235 extending from the circumference of the bottom surface 231 to surround the rotor 220 in a circumferential direction; a plurality of cores 221 disposed on the side wall 235 along the circumferential direction; a plurality of permanent magnets 225 disposed between the plurality of cores 221, respectively; and an outer ring 250 disposed on an outer surface 235b of the side wall 235 that is opposite from the center of the rotor frame 230, in the circumferential direction. The outer ring 250 may be disposed to be spaced from the plurality of cores 221 with the side wall 235 therebetween.

In an embodiment, the rotor frame 230 may include a locking member 251 that protrudes from the outer surface 235b to support the outer ring 250, and the outer ring 250 may include a locking member 251 having a shape corresponding to the locking member 251 such that the locking member 251 is to be inserted therein.

In an embodiment, the rotor frame 230 may include a plurality of locking members 251 arranged to be spaced apart in the circumferential direction, and the outer ring 250 may include a plurality of locking grooves 252 arranged at positions corresponding to respective positions of the plurality of locking members 251.

In an embodiment, the locking groove 252 may be provided as a hole that is formed by penetrating from one surface 250a of the outer ring 250 facing the rotor frame 230 to the other surface 250b thereof in an opposite direction to be opened.

In an embodiment, the rotor frame 230 may include a seating groove 255 that is bent from the outer surface 235b toward the center of the rotor frame 230 to receive therein the outer ring 250.

In an embodiment, the outer ring 250 may include a first surface 250a facing the rotor frame 230, a second surface 250b opposite to the first surface 250a, and a third surface 250c leading to the second surface 250b from the first surface 250a, and the seating groove 255 may include a first bent area 255a formed by being bent from the outer surface 235b of the side wall 235 to face the third surface 250c of the outer ring 250, and a second bent area 255b formed by being bent from the first bent area 255a to face the first surface 250a of the outer ring 250.

In an embodiment, based on a direction of the rotation axis R, the side wall 235 may extend from the bottom surface 231 in a first direction, and the motor assembly 200 may include a shaft 205 which is an output axis connected to the rotor frame 230 in a second direction opposite to the first direction and transferring power to the outside, and a serration 233 formed on the bottom surface 231 of the rotor frame 230 and provided for the shaft 205 to be coupled thereto.

In an embodiment, the plurality of cores 221 may be arranged such that a centroid C2 of the plurality of cores 221 is spaced apart from a centroid C1 of the serration 233 in the first direction, and the outer ring 250 may be arranged such that a centroid C3 of the outer ring 250 is spaced apart from the centroid C2 of the plurality of cores 221 in the first direction.

In an embodiment, a height h2 of the outer ring 250 in the first direction may be smaller than a height h1 of the plurality of cores 221 in the first direction.

In an embodiment, the motor assembly 200 may include a bonding member (not shown) applied between the outer ring 250 and the rotor frame 230 to support the outer ring 250.

In an embodiment, the side wall 235 may include a plurality of first insertion grooves 220a formed therein and a plurality of second insertion grooves 220b respectively disposed between the plurality of first insertion grooves 220a. The plurality of cores 221 may be formed in the plurality of first insertion grooves 220a, and the plurality of permanent magnets 225 may be formed in the plurality of second insertion grooves 220b.

In an embodiment, the outer ring 250 may be disposed to be spaced apart from the plurality of cores 221 and the plurality of permanent magnets 225 with the side wall 235 interposed therebetween.

In an embodiment, the outer ring 250 may be disposed at a distance of substantially between 1 mm and 2 mm from at least some of the plurality of cores 221.

In an embodiment, the rotor 220 may rotate with the plurality of cores 221 and the plurality of permanent magnets 225 positioned in an outward direction opposite to the rotation axis R from the stator 210.

In an embodiment, the motor assembly 200 may be formed by insert-injecting the plurality of cores 221, the plurality of permanent magnets 225, and the outer ring 250 to mold and form the rotor frame 230 such that the rotor frame 230 is formed as a single body.

According to an embodiment, a clothing processing device 100 may include a main body with a tub inside, a drum 20 rotatably disposed inside the tub, and a motor assembly 200 including a stator 210, a rotor 220 electromagnetically interacting with the stator 210 to rotate about a rotation axis R, and a shaft 205 connected to the drum 20 to rotate the drum 20 about the rotation axis R. The rotor 220 may include: a rotor frame 230 including a bottom surface 231 centered on the rotation axis R and a side wall 235 extending from the circumference of the bottom surface 231 to circumferentially surround the rotor 220 in a first direction; a serration 233 formed on the bottom surface 231 of the rotor frame 230 for the shaft 205 to be coupled thereto; a plurality of cores 221 disposed on the side wall 235 along a circumferential direction; a plurality of permanent magnets 225 respectively disposed between the plurality of cores 221; and an outer ring 250 disposed on an outer surface 235b of the side wall 235 opposite from the center of the rotor frame 230, along the circumferential direction. The outer ring 250 may be disposed to be spaced apart from at least some of the plurality of cores 221 with the side wall 235 interposed therebetween. The outer ring 250 may be disposed such that a centroid of the outer ring 250 is spaced apart from a centroid of the plurality of cores 221 in the first direction.

In an embodiment, the rotor frame 230 may include a locking member 251 protruding from the outer surface 235b to support the outer ring 250, and the outer ring 250 may include a locking groove 252 having a shape corresponding to the locking member 251 to allow the locking member 251 to be inserted therein.

In an embodiment, the rotor frame 230 may include a seating groove 255 that is bent from the outer surface 235b toward the center of the rotor frame 230 to receive therein the outer ring 250.

In an embodiment, the plurality of cores 221 may be disposed on the side wall 235 such that a centroid C2 of the plurality of cores 221 is disposed between a centroid C3 of the outer ring 250 and a centroid C1 of the serration 233 based on the first direction.

According to an embodiment, a method S100 of manufacturing a motor assembly 200 including a stator 210 and a rotor 220 electromagnetically interacting with the stator 210 to rotate about a rotation axis R may include: operation S110 of forming a locking groove 252 in an outer ring 250; operation S120 of arranging a plurality of permanent magnets 225 and a plurality of cores 221 inside a cavity of a mold; operation S130 of arranging the outer ring 250 to be spaced apart from the plurality of cores 221 inside the cavity; and operation S140 of injecting a material into the inside of the cavity, and molding and injecting the rotor frame 230 such that the side wall 235 is formed between the plurality of cores 221 and the outer ring 250 and the locking member 251 to be inserted into the locking groove 252 is formed on the side wall 235.

While the disclosure has been shown and described with reference to various embodiments thereof, it will be understood that the various embodiments are intended to be illustrative, not limiting. It will further be understood by those skilled in the art that various changes in form and details may be made without departing from the true spirit and full scope of the disclosure as defined by the appended claims and their equivalents.

What is claimed is:

1. A motor assembly comprising:
a stator; and
a rotor configured to electromagnetically interact with the stator to rotate about a rotation axis,
wherein the rotor includes:
a rotor frame including a bottom surface centered on the rotation axis and a side wall extending from a circumference of the bottom surface to surround the rotor in a circumferential direction of the rotor,
a plurality of cores on the side wall along the circumferential direction,
a plurality of permanent magnets on the side wall along the circumferential direction and between the plurality of cores, respectively, and
an outer ring on an outer surface of the side wall extending along the circumferential direction, and spaced apart from the plurality of cores with the side wall therebetween.

2. The motor assembly of claim 1, wherein
the rotor frame includes a locking member protruding from the outer surface of the side wall and supporting the outer ring, and
the outer ring includes a locking groove having a shape corresponding to the locking member such that the locking member is inserted therein.

3. The motor assembly of claim 2, wherein
the rotor frame includes a plurality of locking members as the locking member such that the plurality of locking members are spaced apart in the circumferential direction, and
the outer ring includes a plurality of locking grooves as the locking groove such that the plurality of locking grooves respectively correspond to positions of the plurality of locking members.

4. The motor assembly of claim 2, wherein the locking groove is a hole that penetrates the outer ring from a first side of the outer ring facing the rotor frame to a second side of the outer ring opposite to the first side.

5. The motor assembly of claim 1, wherein the rotor frame includes a seating groove that is bent from the outer surface of the side wall toward a center of the rotor frame and in which the outer ring is seated.

6. The motor assembly of claim 5, wherein
the outer ring includes a first surface facing the rotor frame, a second surface opposite the first surface, and a third surface extending from the first surface to the second surface, and
the seating groove includes a first bent area bent from the outer surface of the side wall and facing the third surface of the outer ring, and a second bent area bent from the first bent area and facing the first surface of the outer ring.

7. The motor assembly of claim 1, wherein
a rotation shaft is connected to the rotor frame, and
the rotor frame has a serration on the bottom surface of the rotor frame coupling the rotor to the rotation shaft.

8. The motor assembly of claim 7, wherein
the plurality of cores is disposed such that a centroid of the plurality of cores is spaced apart from a centroid of the serration in a direction along an axial direction of the rotation shaft, and
the outer ring is disposed such that a centroid of the outer ring is spaced apart from the centroid of the plurality of cores in the direction along the axial direction of the rotation shaft.

9. The motor assembly of claim 7, wherein the outer ring has a height in the direction along the axial direction of the rotation shaft that is smaller than a height of the plurality of cores in the direction along the axial direction of the rotation shaft.

10. The motor assembly of claim 1, further comprising:
a bonding member between the outer ring and the rotor frame to support the outer ring.

11. The motor assembly of claim 1, wherein the outer ring is spaced apart from the plurality of cores and the plurality of permanent magnets with the side wall therebetween.

12. The motor assembly of claim 1, wherein the outer ring is spaced apart at a distance that is substantially between 1 millimeter (mm) and 2 mm from at least a portion of the plurality of cores.

13. The motor assembly of claim 1, wherein
the side wall includes a plurality of first insertion grooves formed therein and a plurality of second insertion grooves respectively between the plurality of first insertion grooves,
the plurality of cores is formed in the plurality of first insertion grooves, and
the plurality of permanent magnets is formed in the plurality of second insertion grooves.

14. The motor assembly of claim 1, wherein
the rotor is configured to rotate, as the plurality of cores and the plurality of permanent magnets are disposed in an outward direction opposite to the rotation shaft from the stator,
wherein the rotor frame is an injection molded single body.

15. The motor assembly of claim 1, wherein
wherein the rotor frame is an injection molded single body.

16. A clothing processing device including:
a main body in which a tub is provided;
a drum rotatably disposed inside the tub; and
a motor assembly including a stator, a rotor configured to electromagnetically interact with the stator to rotate about a rotation axis, and a shaft connected to the drum to rotate the drum about the rotation axis,
wherein the rotor include:
a rotor frame including a bottom surface centered on the rotation axis and a side wall extending from a circumference of the bottom surface to circumferentially surround the rotor in a direction of the rotation axis;
a serration formed on the bottom surface of the rotor frame and provided for coupling the shaft;
a plurality of cores disposed on the side wall along the circumferential direction;
a plurality of permanent magnets disposed on the side wall along the circumferential direction and disposed between the plurality of cores, respectively; and
an outer ring disposed on an outer surface of the side wall that is opposite to a center of the rotor frame, along the circumferential direction, and
wherein the outer ring is disposed such that a centroid of the outer ring is spaced apart from a centroid of the plurality of cores in the direction of the rotation axis.

17. The clothing processing device of claim 16, wherein
the rotor frame includes a locking member protruding from the outer surface to support the outer ring, and
the outer ring include a locking groove having a shape corresponding to the locking member to allow the locking member to be inserted therein.

18. The clothing processing device of claim 16, wherein
the rotor frame includes a seating groove bent from the outer surface toward the center of the rotor frame to receive therein the outer ring.

19. The clothing processing device of claim 16, wherein
the plurality of cores is disposed on the side wall such that a centroid of the plurality of cores is disposed between a centroid of the outer ring and a centroid of the serration based on the first direction.

20. A method comprising:
forming and an injection molded outer ring having a locking groove;
arranging a plurality of permanent magnets and a plurality of cores inside a cavity of a mold;
arranging the outer ring having the locking groove inside the cavity and spaced apart from the plurality of cores; and
injecting a material into the cavity to form a rotor frame having a side wall between the plurality of cores and the outer ring and a locking member on the side wall and configured to be inserted into the locking groove,
wherein the rotor frame is a rotor frame of a rotor that is electromagnetically interactable with a stator to rotate about a rotation axis.
